(19) United States
(12) Patent Application Publication
(10) Pub. No.: US 2026/0287891 A1
(43) Pub. Date: Sep. 24, 2026

(54) PROTECTIVE ELEMENT OF A UNIT FOR TRANSMITTING CONTROL INFORMATION OF A VEHICLE

(71) Applicant: EYELIGHTS, LABEGE (FR)

(72) Inventors: Patrice NAGTEGAELE, ESCALQUENS (FR); Romain DUFLOT, CASTANET-TOLOSAN (FR)

(21) Appl. No.: 19/479,947

(22) PCT Filed: May 2, 2024
(86) PCT No.: PCT/EP2024/062061

§ 371 Date: Oct. 29, 2025

(30) Foreign Application Priority Data
May 3, 2023 (FR) FR2304448

(51) Int. Cl. G02B 27/01; B60K 35/231; B60K 35/60; G02B 5/30; G02B 27/00

(52) U.S. Cl. CPC G02B 27/0101; B60K 35/231; B60K 35/60; G02B 5/3083; G02B 27/0006; G02B 27/0025; B60K 2360/682; B60K 2360/693; G02B 2027/0112; G02B 2027/013

(57) ABSTRACT

The present invention relates to a protective element (30) of a unit (22) for transmitting control information of a vehicle, the transmission unit (22) comprising at least one screen (28) capable of emitting a light beam, the protective element (30) being suitable for being positioned above and at a distance from the transmission unit (22), on the emission path of the light beam coming from the one or more screens (28) of the transmission unit (22), so as to protect the one or more screens (28), the protective element (30) being at least partially transparent, the protective element (30) having:
an optical magnification property over at least one portion of the protective element (30), and/or
a light-beam redirection property over at least one portion of the protective element (30).

The present invention relates to a protective element of a unit for transmitting control information of a vehicle. The present invention also relates to a head-up display device comprising such a protective element, as well as a vehicle comprising such a head-up display device.

Vehicles, especially automobiles, are equipped with control panels, also known as instrument clusters or dashboards, to present the driver with useful information for driving and operating the vehicle. For this purpose, the control panel comprises the on-board instruments of the vehicle, some of which are mandated by legislation.

For an automobile, the control panel is traditionally integrated into the dashboard of the vehicle under the windshield, behind the steering wheel. Typically, such a control panel is positioned at least at −15° from the line of sight of an average driver looking at the road, about 50 centimeters from the eyes. The driver is then required to take their eyes off the road to view the control panel, which decreases vigilance and increases eye strain due to the constant visual accommodation effort required.

To allow the visualization of useful information more safely, it is known to use head-up displays that retransmit some information from the control panel to the driver.

However, such displays occupy additional space in the vehicle, and some have very bulky projectors, depending on the desired display. Such displays are therefore not always easy to integrate into a vehicle.

There is therefore a need for a means to facilitate the integration of a head-up display device into a vehicle.

To this end, the present description aims at a protective element of a unit for transmitting control information of a vehicle, the transmission unit comprising at least one screen capable of emitting a light beam, the protective element being adapted to be positioned above and at a distance from the transmission unit, on the emission path of the light beam coming from the one or more screens of the transmission unit, so as to protect the one or more screens, the protective element being at least partially transparent, the protective element having:
an optical magnification property, over at least one portion of the protective element, intended to be traversed by at least a part of the light beam from the one or more screens, and/or
a light-beam redirection property, over at least one portion of the protective element, intended to be traversed by at least a part of the light beam from the one or more screens, so as to redirect the light beam from the one or more screens.

According to other advantageous aspects, the protective element comprises one or more of the following features, taken individually or in any technically possible combination:
the protective element is a plate, at least partially transparent, with an entry diopter and an exit diopter, each diopter having an anti-reflective property, the protective element preferably being made of glass or plastic;
the light-beam redirection property of the protective element is achieved by over-molding a film comprising prisms on the protective element and/or by laser micro-structuring of the protective element;
the protective element has a polarization correction property over at least one portion of the protective element, intended to be traversed by at least a part of the light beam from the one or more screens, so as to modify the polarization of the light beam from the one or more screens;
the protective element has a colorimetry correction property over at least one portion of the protective element, intended to be traversed by at least a part of the light beam from the one or more screens, so as to modify the colorimetry of the light beam from the one or more screens;
the protective element has an opacity, with the opacity being fixed or variable by electrochromism or photochromism;
the protective element has a view angle correction property over at least one portion of the protective element, intended to be traversed by at least a part of the light beam from the one or more screens, so as to modify the viewing angle of an image resulting from said light beam, for a driver or a passenger of the vehicle;
the protective element comprises heating elements;
the protective element has a correction property for optical distortion or birefringence, over at least one portion of the protective element, intended to be traversed by at least a part of the light beam from the one or more screens, so as to correct the rendering of an image resulting from said light beam.

The present description also relates to a head-up display device for a vehicle, comprising:
a support suitable for being positioned facing the upper body of a driver in a driving position, the support comprising at least one at least partially reflective portion, called the useful portion,
a unit for transmitting control information of the vehicle, the transmission unit comprising at least one screen capable of emitting a light beam towards the useful portion of the support so that the reflection of the light beam on the support forms at least one useful image in a viewing window of the driver in a driving position, and
a protective element of the transmission unit, the protective element being at least partially transparent, the protective element being positioned above and at a distance from the transmission unit, between the support and the transmission unit, on the emission path of the light beam coming from the one or more screens, so as to protect the one or more screens, the protective element having:
   an optical magnification property, over at least one portion of the protective element, intended to be traversed by at least a part of the light beam from the one or more screens, and/or
   a light-beam redirection property, over at least one portion of the protective element, intended to be traversed by at least a part of the light beam from the one or more screens, so as to redirect the light beam from the one or more screens.

The present description also relates to a vehicle comprising a dashboard and a head-up display device as described above, the protective element being integrated into the dashboard of the vehicle.

Other features and advantages of the invention will appear from the following description of embodiments of the invention, given by way of example only, and with reference to the FIGURE below:

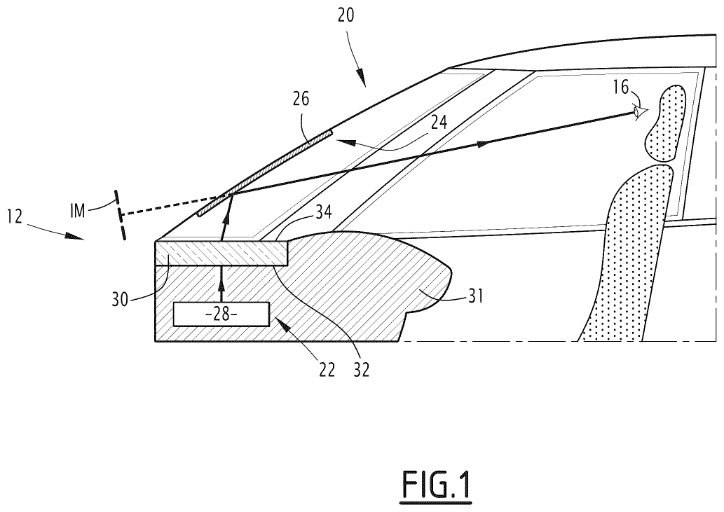

FIG. 1, a schematic representation of an example of a head-up display device integrated into a vehicle, the head-up display device comprising a support, a unit for transmitting control information of the vehicle, and a protective element of the transmission unit.

A head-up display device 12 is illustrated by FIG. 1.

The display device 12 is adapted to be integrated into a vehicle. The vehicle is a land, air, or naval vehicle, for example. The land vehicle is an automobile, a rail vehicle, a two-wheeler (motorized or not), or a three-wheeler (motorized or not), for example.

The display device 12 is suitable for displaying control information of a vehicle to a driver 16 while driving the vehicle. Such control information is information from the onboard instruments of the vehicle, for example, or navigation, safety or communication information from an onboard system in the vehicle or an electronic device of the driver 16, such as a smartphone.

For example, the information relates to a vehicle speed indicator, the energy consumption of the vehicle, alarms related to the malfunction of certain vehicle components, or navigation information (mapping, positions, directions).

In one embodiment, the display device 12 functions as the dashboard of the vehicle in which it is integrated. Thus, in this case, the instruments of the vehicle are only displayed on the display device 12. The dashboard of the vehicle 31 is, therefore, devoid of mechanical instruments integrated into the dashboard 31 and digital instruments integrated into the dashboard 31 different from the display device 12. In this case, the display device 12 is configured to be automatically turned on when the vehicle is started and to be automatically turned off when the vehicle is turned off.

In a variant embodiment, the display device 12 complements the dashboard of the vehicle in which it is integrated.

As illustrated by FIG. 1, the display device 12 comprises a support 20, a unit 22 for transmitting control information of the vehicle, and a protective element 30 of the transmission unit 22.

The support 20 is suitable for being positioned facing the upper body (at least part of the torso) of the driver 16 in a driving position.

The support 20 is transparent or partially transparent, for example. In a variant, the support 20 is opaque.

The support 20 is made of polycarbonate or glass, for example.

The support 20 has at least one portion, called the useful portion 24, which is partially reflective. The useful portion 24 enables generating a virtual image in the field of vision (direct or peripheral) of the driver 16 in a driving position.

In one embodiment, as illustrated by FIG. 1, the partially reflective function of the useful portion 24 is conferred by a reflector element 26. The reflector element 26 is a coating or treatment, for example (obtained by physical deposition or chemical deposition, for example) or a film (laminated or held by electrostatic effect, for example).

The reflector element 26 is placed on the useful portion 24, for example. In a variant, the reflector element 26 is inside the useful portion 24.

In the example of FIG. 1, the useful portion 24 extends over only a portion of the support 20. In a variant, the useful portion 24 extends over the entire support 20.

In the example of FIG. 1, the useful portion 24 has a non-zero curvature so as to form a concave mirror on the side of the driver. In a variant, the useful portion 24 is substantially flat.

Preferably, as illustrated by the example of FIG. 1, the support 20 is an element suitable for deflecting air while driving the vehicle. The support 20 thus functions as a windshield and is called by this name. It is also called a deflector or bubble or even windscreen, especially in the case of two-wheelers. In a variant, the support 20 is a blade also called a “combiner.” In another variant, the support 20 is an opaque panel, such as a portion of the dashboard of the vehicle 31 or a portion of the windshield (screen-printed area).

The transmission unit 22 is suitable for displaying vehicle control information. The information preferably comprises information provided by the instruments of the vehicle or navigation, safety, or communication information from an onboard system in the vehicle or from an electronic device of the driver, such as a smartphone. For this purpose, the transmission unit 22 is suitable for emitting at least one light beam.

The transmission unit 22 comprises at least one screen 28 capable of emitting a light beam towards the useful portion 24 of the support 20, so that the reflection of the light beam on the support 20 forms at least one useful image IM in a viewing window of the driver 16 in a driving position. In a variant, the transmission unit 22 comprises several screens 28.

Preferably, the screen 28 is suitable for displaying a real image from which the light beam from the transmission unit 22 is emitted.

The screen 28 is a liquid crystal display (LCD) or an OLED screen (organic light-emitting diode), for example.

The protective element 30 (also called “cover” in English) is suitable for protecting the transmission unit 22. In particular, the protective element 30 is suitable for protecting the transmission unit 22 from dust, liquids, or shocks.

As illustrated by FIG. 1, the protective element 30 is suitable for being positioned above and at a distance (not in contact) from the transmission unit 22, between the support 20 and the transmission unit 22, on the emission path of the light beam coming from the one or more screens 28, so as to protect the one or more screens 28. The protective element 30 is specifically above and facing the screens 28 of the transmission unit 22 so as to ensure their protection when the transmission unit 22 is integrated into the dashboard of the vehicle 31.

As illustrated in FIG. 1, the display device 12 comprises only the protective element 30 between the transmission unit 22 and the support 20. In other words, the display device 12 does not comprise additional optics placed between the transmission unit 22 and the support 20.

Preferably, as illustrated by FIG. 1, the protective element 30 is integrated into the dashboard of the vehicle 31, the transmission unit 22 being integrated inside the dashboard 31 (thus not directly visible to the driver 16 in a driving position). In this case, the protective element 30 also enables for an aesthetic finish of the dashboard 31. Moreover, the protective element 30 enables for easy cleaning of the transmission unit 22 since it is sufficient to clean the exposed surface of the protective element 30 without having to intervene on the transmission unit 22.

The protective element 30 is at least partially transparent. This enables transmitting the light beam from the one or more screens 28 towards the support 20.

The protective element 30 has one or more optical properties.

In particular, the protective element 30 has an optical magnification property over at least one portion of the protective element 30 intended to be traversed by at least a part of the light beam from the one or more screens 28. This magnification enables reducing the size of the screens 28 while maintaining the same projected image size. This facilitates integration into the vehicle (specifically in the dashboard 31) while reducing costs related to the screens 28.

The protective element 30 has a non-zero optical power (expressed in diopters) on said portion of the protective element 30, for example, allowing, after reflection on the useful surface 24 of the support 20, a magnification of the image from the one or more screens 28 of the transmission unit 22. The optical power is set depending on the desired size for the head-up display image visible to the driver 16, for example.

Depending on the portion of the protective element 30 having a magnification property, the protective element 30 is suitable for magnifying the entirety of the screens 28, the entirety of one screen 28, or local areas of one or more screens 28.

In a variant, the protective element 30 has magnification properties (corresponding to different optical powers) on different portions of the protective element 30, allowing creating a 3D effect for different local areas of a screen 28 or different screens 28.

In a variant or in addition, the protective element 30 has a light-beam redirection property over at least one portion of the protective element 30, intended to be traversed by at least a part of the light beam from the one or more screens 28. This enables redirecting the light beam from the one or more screens 28. Redirecting the light emitted by the one or more screens 28 enables for easier integration into the vehicle (specifically at the dashboard 31).

In one embodiment, the light-beam redirection property of the protective element 30 is achieved by over-molding a film comprising prisms on the protective element 30 and/or by laser micro-structuring of the protective element 30.

Preferably, the protective element 30 is an at least partially transparent plate with an entry diopter 32 and an exit diopter 34. Each diopter 32, 34 has an anti-reflective property. This double anti-reflective property prevents losing brightness at the emission of the screens 28, but also reflections at the protective element 30 on the support 20.

Preferably, the protective element 30 is made of glass (tempered, laminated, etc.) or plastic (polycarbonate, PMMA, etc.).

Preferably, the protective element 30 has a polarization correction property over at least one portion of the protective element 30 intended to be traversed by at least a part of the light beam from the one or more screens 28. This enables modifying the polarization of the light beam from the one or more screens 28.

In one embodiment, the polarization correction property of the protective element 30 is achieved by a polarizing filter applied on or in the protective element 30, for example.

For example, if the polarization of the light emitted by the one or more screens 28 is not optimized for the reflection properties of the useful portion 24 of the support 20, the protective element 30 enables filtering the polarization of the light emitted by the one or more screens 28 locally or over the entirety of the screens 28. Thus, for example, if the useful portion 24 of the support 20 is optimized to reflect a light of polarization P (rectilinear polarization contained in the plane of incidence), the protective element 30 has a filter adapted to let through only the light of polarization P coming from the one or more screens 28.

Preferably, the protective element 30 has a colorimetry correction property over at least one portion of the protective element 30 intended to be traversed by at least a part of the light beam from the one or more screens 28. This enables modifying the colorimetry of the light beam from the one or more screens 28.

In one embodiment, the colorimetry correction property of the protective element 30 is achieved by a colorimetric filter applied on or in the protective element 30.

For example, the reflective treatment of the useful portion 24 of the support 20 is likely to modify the colorimetry of the light emitted by the one or more screens 28, and therefore the colorimetric perception of the driver of the vehicle 16. The colorimetry correction property of the protective element 30 thus enables compensating for this modification.

Preferably, the protective element 30 has an opacity.

In one example, the opacity is fixed. This enables, masking the mechanical integration of the transmission unit 22 into the dashboard of the vehicle 31, for example.

In a variant, the opacity is variable, by electrochromism or photochromism, for example. This enables reducing the brightness of the one or more screens 28 automatically or manually, for example, or masking the mechanical integration of the one or more screens 28 depending on the light conditions.

Preferably, the protective element 30 has a view angle correction property over at least one portion of the protective element 30 intended to be traversed by at least a part of the light beam from the one or more screens 28. This enables modifying the viewing angle of an image IM resulting from said light beam, for a driver 16 or a passenger of the vehicle. This enables, for example, making the light emitted by the one or more screens 28 visible or not depending on the viewing angle. In the case of integration into a vehicle, this enables making certain information visible only to the driver 16 or passengers and thus a certain confidentiality.

In one embodiment, the view angle correction property of the protective element 30 is achieved by a micro-louver film integrated into or on the protective element 30.

Preferably, the protective element 30 comprises heating elements. The heating elements are resistors positioned in or on the protective element 30, for example, The heating elements are suitable for defogging the windshield of the vehicle wherein the protective element 30 is intended to be integrated, for example.

Preferably, the protective element 30 has a correction property for optical distortion or birefringence, over at least one portion of the protective element 30 intended to be traversed by at least a part of the light beam from the one or more screens 28. This enables correcting the rendering of an image IM resulting from said light beam.

For example, the protective element 30 enables correcting local or global optical distortions on the emission area of the one or more screens 28. The protective element 30 also enables correcting the birefringence possibly generated during the manufacture of the support 20, for example. Indeed, in the case of a windshield, the bending of the glass is likely to generate birefringence despite a possible reflective treatment (polarized or not), which generates a residual double image.

In one embodiment, the birefringence correction property is achieved by a retardation plate integrated into the protective element 30.

An example of the operation of the head-up display device 12 will now be described.

At startup, the one or more screens 28 of the transmission unit 22 send a light beam towards the protective element 30. The light beam passes through the protective element and is reflected on the useful portion 24 of the support 20 to form a useful image IM (virtual image) in the field of vision of the driver 16 in a driving position. Depending on the optical properties of the protective element 30, the protective element 30 enables modifying the rendering of the useful image IM, at least by magnifying it and/or modifying its position, or even adapting its visibility or quality.

Thus, the protective element 30 facilitates the integration of a head-up display device 12 into a vehicle through its specific optical properties. In particular, when the protective element 30 has a magnification property, it enables reducing the size of the screens 28 while maintaining the same projected image size. When the protective element 30 has a light-beam redirection property, it enables gaining flexibility for the integration of the head-up display device 12 into the vehicle.

The skilled person will understand that the embodiments described above are likely to be combined with each other when such combinations are compatible.

The skilled person will also understand that the present description is based on the particular case of automobiles, but the invention is not limited to this type of vehicle. The control device is thus adaptable to all types of vehicles, specifically air and naval.

1-11. (canceled)

12. A protective element of a transmission unit for control information of a vehicle, the transmission unit comprising at least one screen capable of emitting a light beam, the protective element being adapted to be positioned above and at a distance from the transmission unit, on the emission path of the light beam coming from the one or more screens of the transmission unit, so as to protect the one or more screens, the protective element being at least partially transparent, the protective element having:
an optical magnification property over at least one portion of the protective element, intended to be traversed by at least a part of the light beam from the one or more screens, and/or
a light-beam redirection property over at least one portion of the protective element, intended to be traversed by at least a part of the light beam from the one or more screens, so as to redirect the light beam from the one or more screens.

13. The protective element according to claim 12, wherein the protective element is an at least partially transparent plate with an entry diopter and an exit diopter, each diopter having an anti-reflective property.

14. The protective element according to claim 13, wherein the protective element is made of glass or plastic.

15. The protective element according to claim 12, wherein the light-beam redirection property of the protective element is achieved by over-molding a film comprising prisms on the protective element and/or by laser micro-structuring of the protective element.

16. The protective element according to claim 12, wherein the protective element has a polarization correction property over at least one portion of the protective element, intended to be traversed by at least a part of the light beam from the one or more screens, so as to modify the polarization of the light beam from the one or more screens.

17. The protective element according to claim 12, wherein the protective element has a colorimetry correction property over at least one portion of the protective element, intended to be traversed by at least a part of the light beam from the one or more screens, so as to modify the colorimetry of the light beam from the one or more screens.

18. The protective element according to claim 12, wherein the protective element has an opacity, the opacity being fixed or variable by electrochromism or photochromism.

19. The protective element according to claim 1, wherein the protective element has a view angle correction property over at least one portion of the protective element, intended to be traversed by at least a part of the light beam from the one or more screens, so as to modify the viewing angle of an image resulting from said light beam, for a driver or a passenger of the vehicle.

20. The protective element according to claim 12, wherein the protective element comprises heating elements.

21. The protective element according to claim 12, wherein the protective element has a correction property for optical distortion or birefringence, over at least one portion of the protective element, intended to be traversed by at least a part of the light beam from the one or more screens, so as to correct the rendering of an image resulting from said light beam.

22. A head-up display device for a vehicle, comprising:
a support suitable for being positioned facing the upper body of a driver in a driving position, the support comprising at least one at least partially reflective portion, called the useful portion,
a transmission unit for control information of the vehicle, the transmission unit comprising at least one screen capable of emitting a light beam towards the useful portion of the support, so that the reflection of the light beam on the support forms at least one useful image in a viewing window of the driver in a driving position, and
a protective element of the transmission unit, the protective element being at least partially transparent, the protective element being positioned above and at a distance from the transmission unit, between the support and the transmission unit, on the emission path of the light beam coming from the one or more screens, so as to protect the one or more screens, the protective element having:
an optical magnification property over at least one portion of the protective element, intended to be traversed by at least a part of the light beam from the one or more screens, and/or
a light-beam redirection property over at least one portion of the protective element, intended to be traversed by at least a part of the light beam from the one or more screens, so as to redirect the light beam from the one or more screens.

23. A vehicle comprising a dashboard and a head-up display device according to claim 22, the protective element being integrated into the dashboard of the vehicle.
